(19) United States
(12) Patent Application Publication
(10) Pub. No.: US 2026/0292509 A1
(43) Pub. Date: Sep. 24, 2026

(54) WI-FI PENETRATION TESTING AND SECURITY AUDIT DEVICE, SYSTEM, AND METHOD WITH AUTOMATED STANDARDIZED REPEATABILITY ENGINE

(71) Applicant: Mohit Garg, Charlotte, NC (US)

(72) Inventor: Mohit Garg, Charlotte, NC (US)

(21) Appl. No.: 19/665,539

(22) Filed: May 1, 2026

(51) Int. Cl. H04W 12/121

(52) U.S. Cl. CPC H04W 12/121

(57) ABSTRACT

An integrated portable handheld Wi-Fi penetration testing and security audit device, system, and method are disclosed. The device integrates a processor, wireless network interface controllers, a dual antenna assembly, and a touchscreen display within a compact housing, eliminating the need for multiple separate tools. A standardized repeatability engine stored in non-volatile memory comprises an audit profile repository, a test execution sequencer, a parameter normalization module, a results database, and a comparison engine. The sequencer automatically executes parameterized sequences of Wi-Fi security test modules. The normalization module adjusts environmental variables to enable meaningful cross-session comparison. The comparison engine identifies changes in wireless security posture over time. The touchscreen display presents a unified audit dashboard with real-time threat mapping, signal analysis, and compliance status. A modular architecture supports firmware and hardware expansion to address emerging wireless security threats.

### PRIORITY CLAIM

This application claims priority to United Kingdom Registered Design No. 6457092, filed Jul. 11, 2025 and granted Jul. 16, 2025, to the extent permitted by applicable law, the entirety of which is incorporated herein by reference.

### CROSS-REFERENCE

This application is related to UK Registered Design No. 6457092 covering the ornamental design of a Wi-Fi Penetration Testing and Security Audit Device. The priority claim to this UK Registered Design is made to the extent permitted under 35 U.S.C. § 119(a) and applicable Paris Convention provisions; applicant reserves the right to modify or withdraw this priority claim upon advice of qualified patent counsel.

### FIELD OF THE INVENTION

The present invention relates generally to cybersecurity hardware and network security assessment systems. More particularly, the invention relates to an integrated, portable, handheld device and associated methods for automated Wi-Fi penetration testing, security auditing, and vulnerability assessment, incorporating a standardized repeatability engine that enables consistent, reproducible, and automated security audit workflows across diverse wireless network environments.

### BACKGROUND OF THE INVENTION

Wireless network security is a critical component of modern information security infrastructure. The proliferation of Wi-Fi enabled devices across enterprise, government, industrial, and consumer environments has created an expansive attack surface that demands rigorous and systematic security assessment.

Wi-Fi penetration testing, also referred to as wireless security auditing, involves the systematic evaluation of wireless network configurations, protocols, and access controls to identify vulnerabilities before malicious actors can exploit them. Such assessments require specialized knowledge, technical expertise, and a variety of specialized tools capable of performing operations including, but not limited to, packet capture and analysis, vulnerability scanning, rogue access point detection, deauthentication testing, handshake capture, and signal strength analysis.

Existing approaches to Wi-Fi penetration testing suffer from significant technical and operational shortcomings. Current toolsets are fragmented, requiring security professionals to carry multiple discrete devices or to configure a general-purpose laptop computer with a collection of disparate software utilities. Such fragmented setups introduce inefficiency, increase the probability of configuration errors, and require substantial setup time that is particularly problematic in time-sensitive or high-security audit environments.

Furthermore, existing tools lack standardized repeatability. A critical deficiency in current Wi-Fi security audit practice is the inability to reliably reproduce test conditions across different audit sessions, different operators, different environments, or different points in time. Without standardized repeatability, organizations cannot reliably compare security posture over time, cannot verify that identified vulnerabilities have been remediated, and cannot produce audit reports that meet regulatory compliance standards requiring demonstrably consistent methodology.

Prior art devices and methods also lack integration of real-time visualization with active testing functions. Security professionals must frequently switch between tools or manually correlate data from different sources, reducing situational awareness during active audits and increasing the risk of missed vulnerabilities.

Additionally, existing solutions are not optimized for portability and ergonomic handheld operation in field environments. General-purpose laptops are cumbersome in physically challenging audit environments such as server rooms, building interiors requiring physical traversal, or industrial facilities. Purpose-built handheld devices in the prior art typically sacrifice functionality for portability or vice versa, failing to provide a comprehensive unified solution.

There exists, therefore, a clear and unmet need in the art for an integrated, portable, handheld Wi-Fi penetration testing and security audit device that consolidates all necessary testing functionalities into a single unit, provides a standardized repeatability engine ensuring consistent and reproducible audit workflows, incorporates real-time visualization of threats and signal analysis, and supports modular expansion to address emerging security protocols and threats.

### SUMMARY OF THE INVENTION

The present invention provides a system and method for automated Wi-Fi penetration testing and security auditing with a standardized repeatability engine. The invention addresses the deficiencies of the prior art by providing a unified, portable, handheld device integrating all necessary hardware and software components for comprehensive wireless security assessment.

In a first aspect, the present invention provides an integrated Wi-Fi penetration testing and security audit device comprising: a portable handheld housing containing a processor, one or more wireless communication modules, one or more antennas, a touchscreen display, one or more configurable hardware input controls, and a non-volatile memory storing a standardized repeatability engine. The standardized repeatability engine is configured to define, store, execute, and compare standardized audit test sequences in a manner ensuring consistent and reproducible results across multiple audit sessions.

In a second aspect, the present invention provides a method for automated Wi-Fi penetration testing and security auditing comprising the steps of: receiving a selection of a standardized audit profile from a user; automatically executing a defined sequence of Wi-Fi security tests according to the standardized audit profile; capturing and storing test parameters and results in a standardized format; comparing results against baseline measurements and previous audit sessions; and generating a compliance audit report reflecting the standardized test methodology and results.

In a third aspect, the present invention provides a standardized repeatability engine for Wi-Fi security auditing comprising: an audit profile repository storing a plurality of standardized test profiles; a test execution sequencer configured to automatically execute tests in a defined order with defined parameters; a parameter normalization module configured to normalize environmental variables to ensure comparable results across different test sessions and environments; a results database configured to store test results in a standardized schema; and a comparison engine configured to compare results across audit sessions to identify changes in security posture.

A principal object of the present invention is to provide a single integrated handheld device that eliminates the need for multiple separate tools in Wi-Fi security auditing, thereby reducing setup time and operational complexity.

Another object of the invention is to provide a standardized repeatability engine that ensures audit results are consistent, comparable, and reproducible regardless of the operator, environment, or time of audit, thereby enabling compliance with regulatory audit standards and enabling reliable trend analysis of an organization's wireless security posture over time.

A further object of the invention is to provide real-time visualization of wireless network threats, signal strength, and audit progress through an integrated touchscreen dashboard, thereby improving situational awareness during active security assessments.

Yet another object of the invention is to provide a modular architecture supporting firmware updates and hardware expansion modules, ensuring the device remains capable of addressing emerging wireless security threats and protocols over time.

### BRIEF DESCRIPTION OF THE DRAWINGS

The accompanying drawings, which are incorporated in and constitute a part of this specification, illustrate preferred embodiments of the invention and together with the description serve to explain the principles of the invention. FIGS. 1 through 6 are reproduced from United Kingdom Registered Design No. 6457092 with reference numerals added. FIGS. 7 through 10 are original functional diagrams.

FIG. 1 is a perspective isometric view of the integrated Wi-Fi security audit device 100 showing the touchscreen display 140, dual antenna assembly 130 comprising antennas 132a and 132b, hardware input controls 150a, 150b, and 150c, LED status indicators 155, indicator elements 156, and housing 102.

FIG. 2 is a front elevational view of the device 100 showing the touchscreen display 140, hardware input controls 150a, 150b, and 150c stacked on the right side, LED status indicators 155 in two groups of three, and indicator elements 156 at the top center of the face.

FIG. 3 is a rear elevational view of the device 100 showing the housing 102, dual antenna assembly 130 comprising antennas 132a and 132b of equal height centered on the top of the device, and power management control 180.

FIG. 4 is a left side elevational view of the device 100 showing the housing 102 profile, single antenna 132 at the rear, data interface port 160 on the left face, ventilation elements 181 and charging port 182 at the base.

FIG. 5 is a base view of the device 100 showing the housing 102 base with four mounting points 185 at the corners, ventilation elements 181 on the left and right zones, and the charging port 182 at the bottom center.

FIG. 6 is a rear elevation port detail view of the device 100 showing the recessed port panel with the three USB data interface ports 160 in the upper row, the SD card slot 162 and audio connectivity ports 161 in the lower row, the dual antenna assembly 130 comprising antennas 132a and 132b, and the power management control 180.

FIG. 7 is a block diagram of the system architecture of the device 100 showing the central processing unit 110, wireless communication subsystem 120 comprising NICs 122a and 122b, antenna assembly 130, touchscreen display 140, hardware input controls 150, non-volatile memory 170, power management subsystem 180, data interface ports 160, and standardized repeatability engine 200, all enclosed within housing 102.

FIG. 8 is a flowchart of method 300 for automated Wi-Fi security auditing illustrating the sequential steps from profile selection through test execution, parameter normalization, result storage, the completion decision, comparison engine analysis, report generation, and output.

FIG. 9 is a detailed block diagram of the standardized repeatability engine 200 illustrating the audit profile repository 210, test execution sequencer 220, parameter normalization module 230, results database 240, comparison engine 250, and report generation module 260 with their data flow interconnections and output blocks including the session archive, posture score trend analysis, and signed audit report.

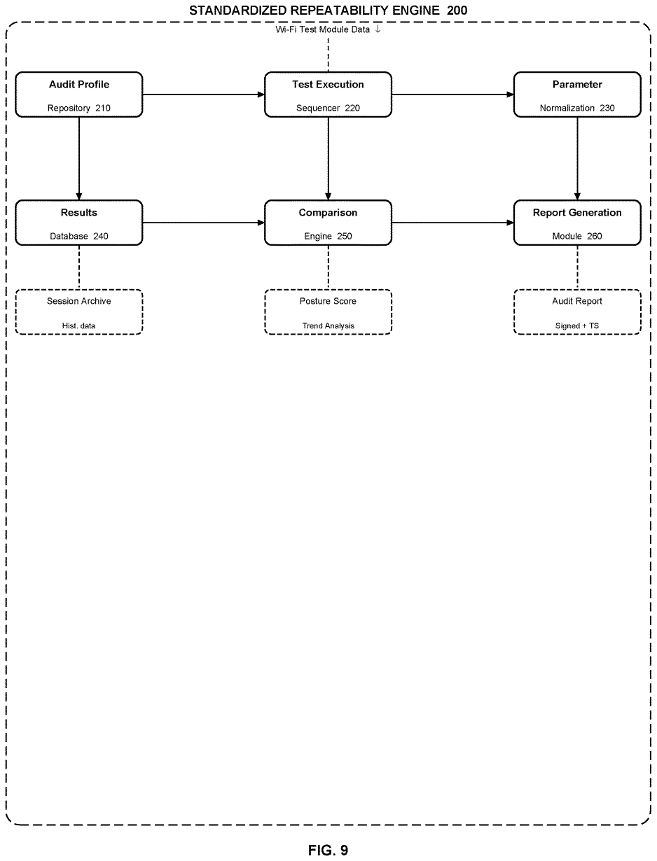

FIG. 10 is a flowchart of the normalization algorithm framework implemented by the parameter normalization module 230, illustrating the sequential operations of session initialization calibration sweep, signal strength normalization using the log-distance path loss model, interference compensation normalization, temporal normalization, Session Environmental Baseline Record storage, and cross-session comparison with differential baseline correction.

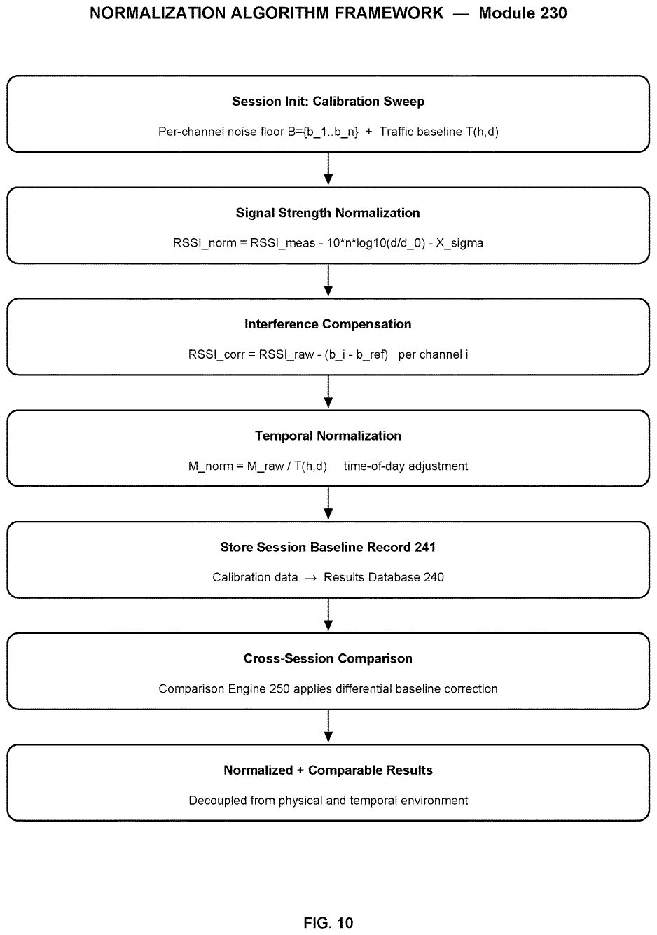

### DETAILED DESCRIPTION OF THE PREFERRED EMBODIMENTS

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention.

As used herein, the term “penetration testing” refers exclusively to authorized wireless network security assessment activities conducted by qualified cybersecurity professionals acting with the explicit written permission of the network owner or authorized administrator, solely for the lawful purpose of identifying, evaluating, and facilitating the remediation of security vulnerabilities within the assessed network infrastructure. The present invention is designed, intended, and suitable solely for such lawful, authorized security assessment and audit use. Nothing in this specification or claims shall be construed to facilitate, enable, or encourage unauthorized access to any wireless network or computing system. All references to penetration testing, vulnerability assessment, packet capture, deauthentication testing, and related security audit functions throughout this specification are made exclusively in the context of authorized, lawful network security assessment conducted with the knowledge and consent of the network owner.

### I. Overview of the System

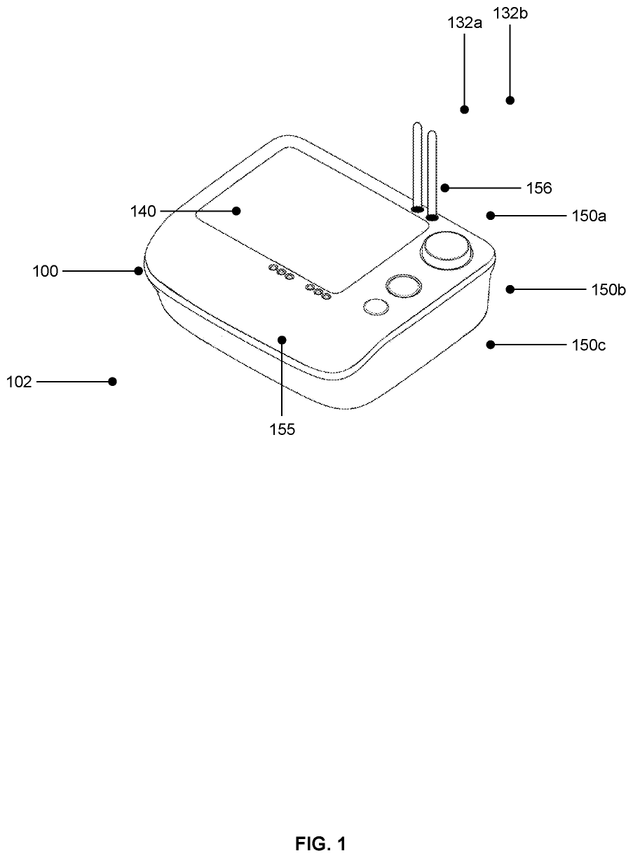

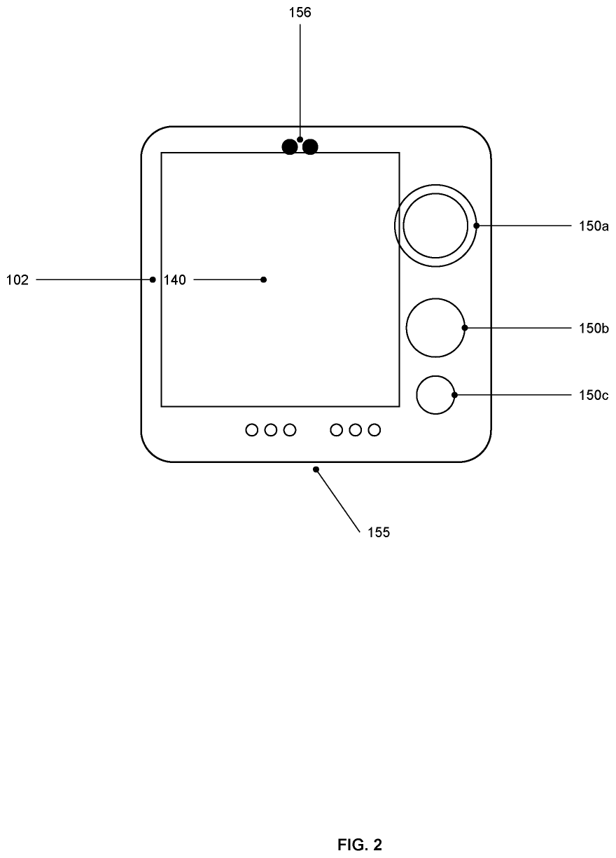

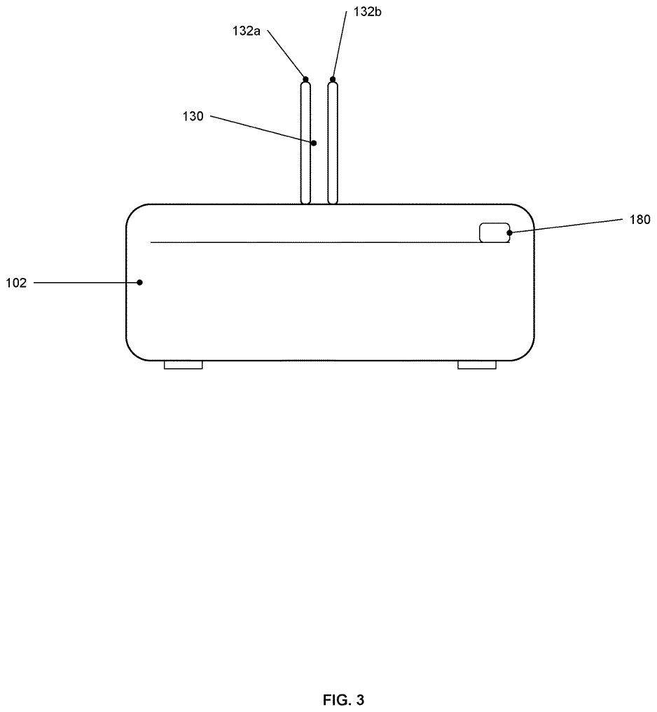

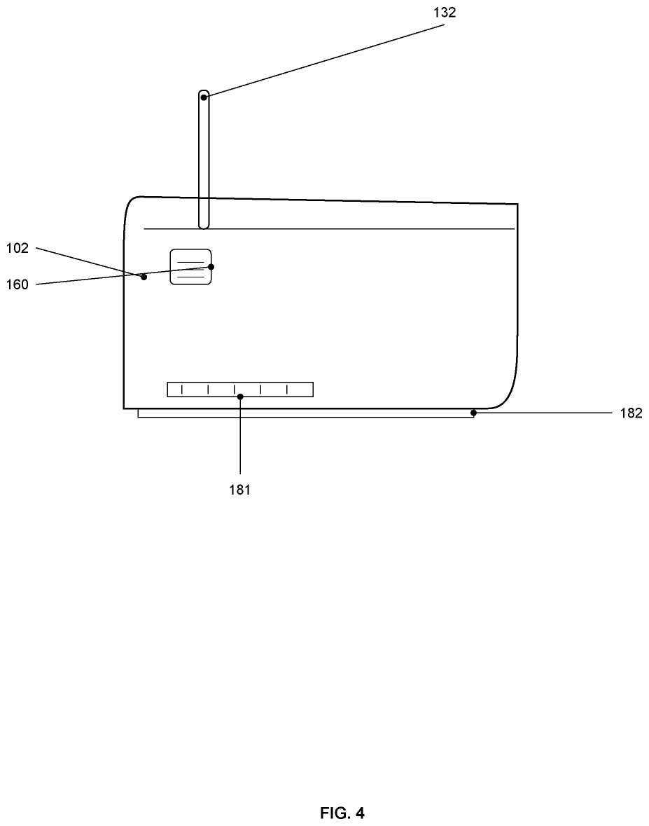

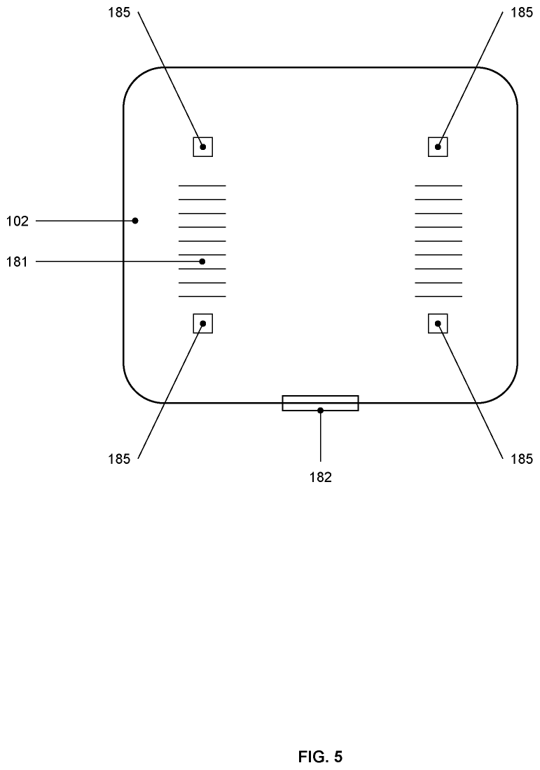

Referring now to FIG. 1 through FIG. 5, the integrated Wi-Fi penetration testing and security audit device 100 according to a preferred embodiment of the present invention is illustrated. The device 100 comprises a portable handheld housing 102 designed for ergonomic single-hand or two-hand operation in field environments. The housing 102 encloses all necessary electronic and computing components in a compact, integrated form factor that eliminates the need for external peripherals during wireless security assessments. The housing 102 incorporates four mounting points 185 disposed at the base corners enabling rack mounting, surface attachment, and tripod mounting for fixed-position deployment scenarios.

The device 100 is operable as a standalone unit capable of performing comprehensive Wi-Fi penetration testing and security audit functions including, without limitation, packet capture and analysis, Wi-Fi network enumeration and mapping, vulnerability scanning, rogue access point detection, deauthentication frame analysis, WPA/WPA2/WPA3 handshake capture, signal strength mapping, compliance assessment, and standardized audit report generation.

### II. Hardware Architecture

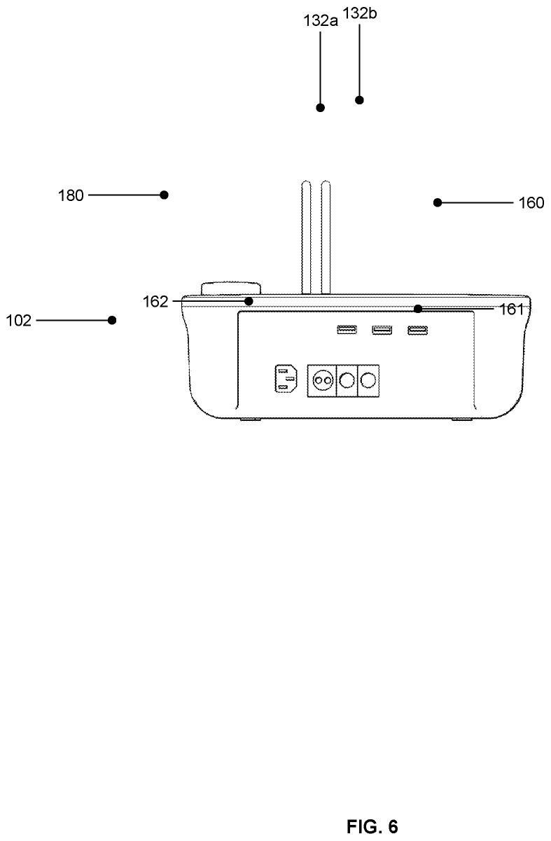

Referring to FIG. 6, the system architecture of the device 100 is illustrated. The hardware components of the device 100 provide the computational substrate upon which the standardized repeatability engine 200 operates. The device 100 comprises a central processing unit (CPU) 110 providing sufficient computational resources for concurrent execution of multiple engine components—the test execution sequencer 220, parameter normalization module 230, and comparison engine 250—alongside active wireless interface management and real-time packet processing.

The wireless communication subsystem 120 comprises at least two independent wireless network interface controllers (NICs) 122a and 122b, each operable across IEEE 802.11 protocol variants in the 2.4 GHz, 5 GHz, and 6 GHz frequency bands in both monitor mode and managed mode. The dual-NIC architecture is a prerequisite for the deterministic execution model of the test execution sequencer 220: it enables the sequencer to assign monitoring and active testing functions to separate hardware interfaces, preventing cross-contamination of concurrent test module measurements—a capability that single-NIC prior art configurations cannot provide.

The antenna assembly 130 comprises one or more external antennas 132 mounted on the housing 102. In a preferred embodiment, the antenna assembly 130 comprises dual external antennas providing enhanced signal reception and transmission capability for extended range operation and improved signal quality during field assessments. The antenna assembly 130 is configured for operation in both monitor mode and managed mode to support the full range of wireless security testing functions.

The touchscreen display 140 serves as the primary output interface for the standardized repeatability engine 200, presenting the Unified Audit Dashboard through which the engine communicates real-time test execution state, normalized measurement results, and compliance assessment status to the operator. The touchscreen display 140 is operatively coupled to the test execution sequencer 220 such that operator interactions—profile selection, test parameter overrides within profile-permitted bounds, and session control commands—are communicated directly to the engine rather than to individual test tools, preserving the deterministic execution model of the standardized repeatability engine 200.

Hardware input controls 150 provide physical trigger mechanisms that invoke pre-defined profile actions within the standardized repeatability engine 200. Each hardware control 150 is mappable to a specific audit profile action—such as initiating a defined test sequence, marking a location reference point in a mobile scan path, or flagging a measurement for manual review—enabling operators to interact with the engine without interrupting active test execution or navigating the touchscreen interface. This direct hardware-to-engine coupling is particularly significant during mobile audit sessions where touchscreen interaction is impractical.

Data interface ports 160 support export of audit results from the results database 240 and import of audit profiles 212 into the audit profile repository 210, enabling the device 100 to participate in enterprise-wide audit profile management workflows in which standardized profiles are distributed to multiple devices from a centralized profile management server. An SD card slot 162 provides removable storage for portable audit data export and profile import. Audio and connectivity ports 161 provide supplementary interface capability for specialized testing accessories and external audio monitoring.

Non-volatile memory 170 stores the standardized repeatability engine 200, the audit profile repository 210 including all audit profiles 212 and Compliance Mapping Records 213, the results database 240 including all Session Environmental Baseline Records 241 and historical audit session data, and the machine learning behavioral baseline model maintained by the anomaly detection module. The non-volatile memory 170 provides sufficient capacity for retention of multi-year audit histories, which is a prerequisite for the longitudinal security posture trend analysis capabilities of the comparison engine 250.

A power management subsystem 180 comprises a rechargeable battery providing sufficient capacity for extended field operation. The power management subsystem 180 incorporates power optimization features enabling sustained operation during resource-intensive testing sequences. A charging port 182 disposed on the base of the housing 102 provides the primary power input interface. Ventilation elements 181 disposed on the base of the housing 102 provide thermal management for the processor 110 and wireless communication subsystem 120 during extended operation.

### III. The Standardized Repeatability Engine

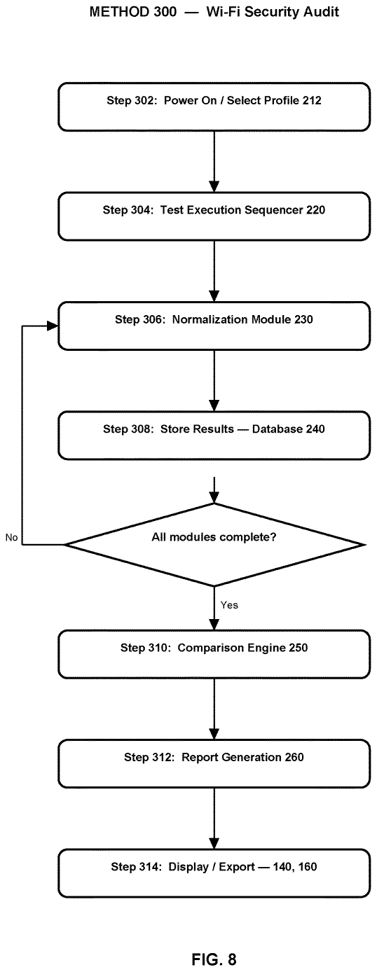

Referring to FIG. 8, the standardized repeatability engine 200 represents a core inventive aspect of the present invention. The standardized repeatability engine 200 is a software and data framework stored in and executed by the device 100 that enables consistent, reproducible, and comparable Wi-Fi security audit workflows across multiple audit sessions, operators, and environments.

Prior art Wi-Fi security auditing suffers from a fundamental and non-trivial technical problem that cannot be solved by mere software integration or operational procedure changes: the absence of any mechanism to achieve deterministic test execution under variable RF environmental conditions. Unlike wired network testing, where the physical channel characteristics are substantially fixed, Wi-Fi security testing takes place in a shared, uncontrolled RF medium where ambient interference levels, multipath propagation characteristics, channel occupancy, and client device density vary continuously and unpredictably. These variations directly corrupt the measurements produced by security test modules—a network that appears to have a weaker signal profile in one session than another may be unchanged in its security configuration; the apparent change reflects only a change in ambient interference. Prior art tools—including Aircrack-ng, Kismet, and WiFi Pineapple—record raw RF measurements without any normalization framework, making cross-session comparison scientifically unreliable. Furthermore, existing tools execute test sequences under operator control, introducing inter-operator variability: different operators make different ad-hoc decisions about scan duration, channel selection order, and sampling frequency, producing results that cannot be meaningfully compared even when the same toolchain is used. Solving this problem requires not merely executing a fixed script, but implementing a mathematical normalization framework calibrated to the specific environmental conditions of each audit session—a capability that requires the integration of signal processing algorithms, deterministic execution scheduling, and cross-session baseline comparison, none of which exist in prior art tooling either individually or in combination.

The standardized repeatability engine 200 addresses this critical deficiency through a structured framework comprising the following components.

An audit profile repository 210 stores a plurality of standardized audit profiles 212. Each audit profile 212 defines a complete, parameterized test sequence specifying: the ordered sequence of test modules to be executed; the configuration parameters for each test module including scan duration, packet capture volume thresholds, signal strength measurement intervals, and detection sensitivity levels; the environmental normalization parameters to be applied during result processing; the pass/fail criteria for each test module; and the output format specification for the generated audit report. Audit profiles 212 may be pre-configured to correspond to recognized security standards and compliance frameworks, custom-configured by the operator, or downloaded from a centralized profile repository.

A test execution sequencer 220 implements deterministic test execution under variable RF environmental conditions—the core technical challenge that prior art audit tools cannot address. The test execution sequencer 220 receives the ordered test module sequence and associated execution parameters from the selected audit profile 212 and manages the allocation of the dual wireless network interface controllers 122a and 122b across concurrently active test modules, ensuring that no test module is assigned to a NIC that is already committed to a concurrent monitoring task that would corrupt the test module's measurements. The test execution sequencer 220 enforces strict temporal sequencing—test modules that share RF resources are executed in a defined serialized order rather than concurrently, while test modules that operate on independent RF resources may execute in parallel subject to processor and memory availability constraints defined in the profile. At each test module transition, the test execution sequencer 220 consults the current session environmental baseline maintained by the parameter normalization module 230 to determine whether the RF environment has changed materially since the last baseline calibration; if the change exceeds a configured threshold, the test execution sequencer 220 triggers a re-calibration cycle before proceeding to the next test module. This continuous environmental monitoring and adaptive scheduling ensures that each test module in a session executes under conditions that have been characterized by the current calibration state, rather than by a stale baseline that may no longer reflect the actual RF environment.

A parameter normalization module 230 addresses a fundamental technical barrier that renders prior art Wi-Fi audit tools incapable of producing cross-session comparable results: the absence of any systematic mechanism to mathematically decouple security-relevant signal measurements from the physical and temporal variables that contaminate those measurements. Prior art tools record raw RSSI values, raw packet counts, and raw channel utilization figures without reference to a calibrated environmental baseline, making it impossible to determine whether a change in a measured value between two audit sessions reflects a genuine change in security posture or merely a change in physical conditions such as interference level, operator distance, atmospheric attenuation, or time-of-day traffic variation. The parameter normalization module 230 solves this problem through a multi-dimensional normalization framework comprising three coordinated algorithmic components described in paragraphs [0044] and [0045] below.

The parameter normalization module 230 implements a Normalization Algorithm Framework comprising the following signal processing operations applied to raw test module outputs prior to storage in the results database 240. First, Signal Strength Normalization: received signal strength indicator (RSSI) measurements are normalized using a log-distance path loss model expressed as: RSSI_normalized=RSSI_measured−10·n·log10(d/d0)−X_sigma, where n is the path loss exponent derived from an environment-type classifier (open space: n=2.0; office: n=2.8; dense urban: n=3.5), d0 is a reference distance of one meter, d is the estimated operator distance derived from time-of-flight measurement or manual entry, and X_sigma is a zero-mean Gaussian shadow fading correction term with standard deviation sigma estimated from the variance of repeated measurements at a fixed reference point collected during session initialization. Second, Interference Compensation Logic: the ambient RF interference floor is sampled across all active channels at session start, producing a per-channel interference baseline vector B={b1, b2, . . . , bn} where bi is the measured noise floor on channel i in dBm.

Each subsequent RSSI measurement on channel i is corrected as: RSSI_corrected=RSSI_raw−(bi−b_ref), where b_ref is the reference noise floor from a stored clean-environment calibration profile. This correction removes the contribution of time-varying ambient interference to measured signal strength, isolating the access-point-specific signal component. Third, Time-Based Variance Adjustment: network traffic volume, channel utilization, and client device count measurements exhibit strong diurnal periodicity. The parameter normalization module 230 maintains a time-indexed traffic baseline model T(h, d) representing expected network activity as a function of hour-of-day h and day-of-week d, derived from historical session data stored in the results database 240. Raw traffic measurements M are normalized as: M_normalized=M_raw/T(h, d), producing a utilization ratio that is comparable across sessions conducted at different times of day or days of the week. [0045] Cross-Session Baseline Calibration: the parameter normalization module 230 implements a deterministic session initialization protocol that establishes an environmental baseline prior to each audit session, enabling the normalization algorithms described in paragraph [0044] to operate with session-specific calibration parameters rather than relying on static reference values. At session initialization, the test execution sequencer 220 suspends test module execution and directs the parameter normalization module 230 to execute a calibration sweep comprising: (i) passive channel scan across all supported frequency bands to measure per-channel ambient noise floor and interference sources; (ii) beacon frame collection from all detected access points to establish a signal strength reference map associating each BSSID with a baseline RSSI and estimated path loss exponent; and (iii) traffic volume sampling over a configurable baseline window (default: 60 seconds) to establish a current-session traffic baseline for time-of-day normalization. These calibration measurements are stored as the Session Environmental Baseline Record 241 within the results database 240. The Comparison Engine 250 uses the Session Environmental Baseline Records from both the current session and any reference session when computing cross-session security posture comparisons, applying differential baseline correction to eliminate the contribution of differing environmental conditions from the computed posture delta. This deterministic baseline calibration protocol ensures that two audit sessions of the same network conducted under materially different physical conditions—different ambient interference levels, different times of day, different operator positions—will produce normalized results that accurately reflect only the genuine changes in the network's security configuration, not artifacts of the differing physical contexts.

A results database 240 stores audit results in a standardized schema ensuring consistent data structure across audit sessions. The results database 240 stores raw measurement data, normalized results, pass/fail determinations, and metadata including audit date, time, operator identification, device configuration, and environmental parameters. The standardized schema enables reliable programmatic comparison and analysis of results across audit sessions.

A comparison engine 250 performs multi-dimensional security posture analysis across normalized audit session results stored in the results database 240. The comparison engine 250 computes a Wireless Security Posture Score (WSPS) for each audit session using a weighted severity model: WSPS=100−SUM(wi*si*pi), where wi is the weight assigned to vulnerability category i (configurable per audit profile, with default weights reflecting the relative severity of encryption weaknesses, authentication vulnerabilities, rogue device presence, and configuration deficiencies), si is the severity multiplier for the detected vulnerability (Critical: 4.0; High: 3.0; Medium: 2.0; Low: 1.0; Informational: 0.5), and pi is the persistence factor representing the number of consecutive audit sessions in which the vulnerability has been present (pi=1 for newly detected vulnerabilities, increasing by 0.5 per consecutive session in which the vulnerability persists unmediated). This persistence weighting reflects the security principle that unmediated vulnerabilities of known existence represent a greater organizational risk than newly discovered ones. The comparison engine 250 computes a Posture Delta Score between any two selected sessions as: PDS=WSPS_current−WSPS_prior, where a positive PDS indicates security posture improvement and a negative PDS indicates degradation. The comparison engine 250 further classifies individual vulnerability changes as: New (present in current session, absent in reference session), Remediated (absent in current session, present in reference session), Persistent (present in both sessions), and Regressed (present in current session with higher severity than in reference session).

A report generation module 260 generates standardized audit reports in formats suitable for regulatory compliance documentation, management reporting, and technical remediation guidance. The report generation module 260 incorporates digital signature and timestamp mechanisms ensuring report integrity and non-repudiation.

### IV. Unified Testing Interface

IV-A. Audit Standardization Framework [0050] The standardized repeatability engine 200 implements an Audit Standardization Framework that maps the parameterized test sequences stored in the audit profile repository 210 to recognized wireless security compliance methodologies and industry-standard assessment frameworks. This mapping constitutes a distinct inventive contribution beyond the Repeatability Engine components described in paragraphs [0041] through [0048]: it enables the device 100 to function not merely as a test execution platform, but as a compliance documentation system capable of generating audit evidence that satisfies the evidentiary requirements of formal regulatory and certification processes. [0051] Each audit profile 212 stored in the audit profile repository 210 may include a Compliance Mapping Record 213 that associates each test module in the profile's execution sequence with one or more specific control requirements drawn from recognized security frameworks. In a preferred embodiment, the Compliance Mapping Record 213 supports mappings to the following framework structures: (i) NIST SP 800-153 (Guidelines for Securing Wireless Local Area Networks)—mapping Wi-Fi security test modules to the NIST WLAN security control categories including authentication controls, encryption configuration controls, rogue device detection controls, and monitoring controls; (ii) ISO/IEC 27001 Annex A.8 (Technological Controls) and Annex A.13 (Network Security)—mapping test module results to the information security control objectives for wireless network access management and network segregation; (iii) PCI-DSS Requirement 1.3 and Requirement 4.2—mapping vulnerability assessment and encryption test module results to the PCI-DSS wireless security requirements for cardholder data environments; and (iv) custom compliance schema definitions that allow enterprise security teams to define proprietary control frameworks and map test module outputs to custom control identifiers. The Compliance Mapping Record 213 is stored as a structured data component of the audit profile 212 and is processed by the report generation module 260 to produce compliance gap reports that identify specific control deficiencies with references to the applicable framework control identifier, the test module result that identified the deficiency, and the remediation action required to achieve compliance. [0052] The Audit Standardization Framework further comprises a Deterministic Test Sequencing Protocol implemented by the test execution sequencer 220 that ensures audit reproducibility under variable RF conditions—a technical requirement that is fundamentally distinct from the reproducibility achievable by general-purpose scripting frameworks. The Deterministic Test Sequencing Protocol defines, for each test module in an audit profile 212, a set of Execution Invariants: mandatory pre-conditions that must be verified before test module execution commences, a defined execution window with configurable timeout and retry parameters, and a set of acceptance criteria that determine whether the test module's output is accepted as a valid measurement or flagged for re-execution. When a test module's output fails its acceptance criteria—for example, when a signal strength measurement exhibits variance exceeding a configurable threshold due to transient interference—the Deterministic Test Sequencing Protocol automatically schedules a re-execution of the affected module within the same audit session, ensuring that the stored results reflect valid, stable measurements rather than transient artifacts. This self-correcting execution model is technically non-trivial because it requires the test execution sequencer 220 to maintain concurrent awareness of: the current execution state of each active test module; the environmental baseline measurements produced by the parameter normalization module 230; and the acceptance criteria defined in the active audit profile 212—and to make real-time scheduling decisions based on the interaction of all three. No prior art Wi-Fi security tool or toolchain implements a comparable deterministic execution model. [0053] The device 100 presents a unified testing interface through the touchscreen display 140 enabling an operator to conduct the full range of Wi-Fi security audit functions without switching between tools or devices. The unified testing interface comprises an audit dashboard displaying real-time test status, a network visualization panel displaying detected networks and associated security information, a threat mapping display identifying detected vulnerabilities and anomalies, a signal strength analyzer providing spatial visualization of signal coverage, and a compliance status panel displaying real-time compliance assessment against selected standards.

In a preferred embodiment, the unified testing interface incorporates a guided audit workflow mode in which the standardized repeatability engine 200 directs the operator through each step of a selected audit profile 212, displaying prompts, status information, and real-time results as each test module executes. The guided audit workflow mode reduces the operator expertise required to conduct comprehensive Wi-Fi security assessments and eliminates operator-introduced procedural variability.

### V. Wi-Fi Security Testing Modules

The device 100 incorporates a plurality of Wi-Fi security testing modules executable under direction of the standardized repeatability engine 200. In a preferred embodiment, the testing modules include without limitation:

A network enumeration module configured to discover and catalog all wireless networks within range, including hidden networks, and to collect associated information including network name (SSID), MAC address (BSSID), operating frequency band, channel, signal strength, security protocol, and cipher suite.

A packet capture module configured to capture wireless frames transmitted on specified channels and frequencies for subsequent analysis. The packet capture module is configurable for targeted capture of specific frame types including management frames, authentication frames, and data frames.

A vulnerability assessment module configured to systematically test wireless networks for known vulnerabilities including, without limitation, weak encryption configurations, default credential usage, WPS vulnerabilities, PMKID capture susceptibility, and misconfigured access points.

A rogue access point detection module configured to identify unauthorized access points within the assessed environment, including evil twin access points, honeypot networks, and access points not conforming to the organization's authorized network inventory.

A signal strength analysis module configured to measure and map wireless signal strength and quality across a physical space, identifying coverage gaps, interference sources, and optimal access point placement.

A compliance assessment module configured to evaluate wireless network configurations against specified security standards and compliance frameworks, generating compliance gap reports identifying specific configuration deficiencies.

### VI. Modular and Upgradeable Architecture

The standardized repeatability engine 200 implements a versioned modular architecture in which the audit profile repository 210, test execution sequencer 220, parameter normalization module 230, and comparison engine 250 are independently updatable components. Each component carries a version identifier that is recorded in the Session Environmental Baseline Record 241 at the time of each audit session, enabling the comparison engine 250 to identify and flag cross-session comparisons in which different component versions were used, and to apply version-specific compatibility transformations where appropriate. This versioned architecture ensures that longitudinal security posture analysis spanning multiple years of audit sessions remains methodologically valid even as individual engine components are updated to address new vulnerability classes, support new wireless protocols, or incorporate improved normalization algorithms. Engine component updates are delivered as cryptographically signed update packages that are verified by the device 100 before installation, ensuring update integrity and preventing unauthorized modification of the normalization or comparison logic that underlies the reliability of the audit results.

In a preferred embodiment, the hardware expansion architecture supports connection of specialized wireless adapters, additional antenna configurations, and specialized testing accessories through the data interface ports 160, enabling expansion of the device's testing capabilities for specialized environments or emerging wireless protocols.

### VII. Method of Operation

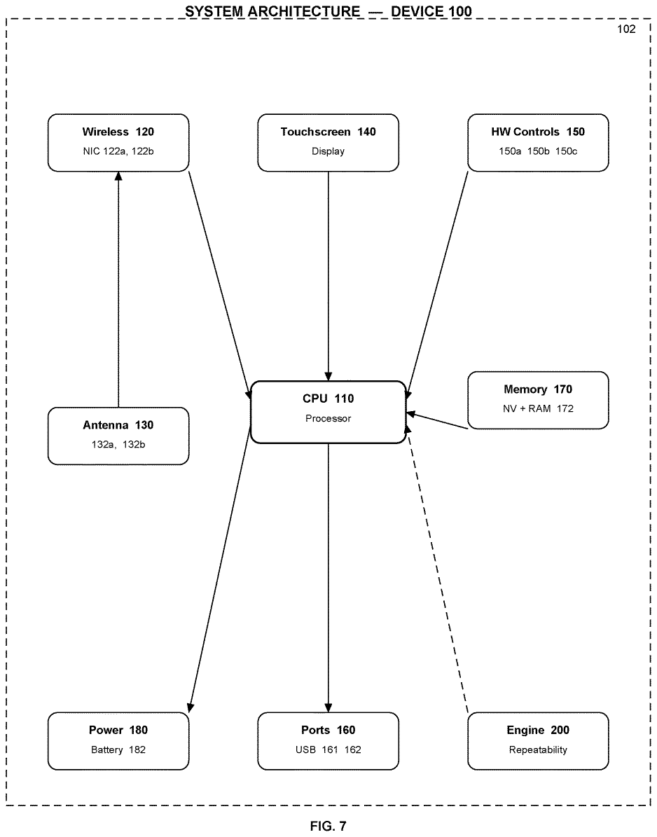

Referring to FIG. 7, a method 300 for automated Wi-Fi penetration testing and security auditing according to an embodiment of the present invention is illustrated. The method 300 comprises the following steps.

At step 302, the operator powers on the device 100 and selects an audit profile 212 from the audit profile repository 210 using the touchscreen display 140 or hardware input controls 150. The selected audit profile 212 specifies the complete test sequence, parameters, and compliance framework for the audit session.

At step 304, the test execution sequencer 220 initiates execution of the audit profile 212, automatically launching each test module in the defined sequence with the defined parameters. The touchscreen display 140 presents real-time progress and preliminary results as each test module executes.

At step 306, the parameter normalization module 230 applies normalization algorithms to captured data and measurements, adjusting for environmental variables to produce normalized results comparable to results from previous audit sessions.

At step 308, as each test module completes, results are stored in the results database 240 in the standardized schema associated with the current audit session.

At step 310, upon completion of all test modules defined in the audit profile 212, the comparison engine 250 compares the current audit session results against results stored from previous audit sessions, identifying changes in security posture, newly identified vulnerabilities, and remediated vulnerabilities.

At step 312, the report generation module 260 generates a standardized audit report incorporating the current session results, comparison analysis, compliance assessment, and remediation recommendations.

At step 314, the generated audit report is displayed on the touchscreen display 140 and optionally transmitted to a connected management system or exported through the data interface ports 160.

### VIII. Alternative Embodiments

While the foregoing description sets forth preferred embodiments of the invention, those skilled in the art will understand that various modifications and alternative configurations are within the scope of the invention.

In an alternative embodiment, the device 100 may incorporate cellular network connectivity enabling real-time synchronization of audit profiles and results with a centralized management platform, enabling fleet management of multiple devices deployed across an enterprise security team.

In another alternative embodiment, the device 100 may incorporate machine learning-based anomaly detection capabilities trained on baseline network behavior profiles, enabling detection of behavioral anomalies not captured by signature-based vulnerability detection methods.

In yet another alternative embodiment, the standardized repeatability engine 200 may incorporate a multi-operator coordination mode enabling synchronized, coordinated audit sessions conducted by a team of operators using multiple devices, with results automatically aggregated into a unified audit report.

What is claimed is:

1. An integrated Wi-Fi penetration testing and security audit device, comprising:
a portable handheld housing;
a processor disposed within the housing;
at least one wireless network interface controller operatively connected to the processor and configured for operation in monitor mode and managed mode across a plurality of Wi-Fi frequency bands and protocols;
at least one antenna assembly mounted on the housing and connected to the wireless network interface controller;
a touchscreen display mounted on the housing and operatively connected to the processor;
one or more configurable hardware input controls disposed on the housing; and
non-volatile memory storing a standardized repeatability engine executable by the processor, the standardized repeatability engine comprising:
an audit profile repository storing a plurality of standardized audit profiles, each audit profile defining a parameterized sequence of Wi-Fi security test modules;
a test execution sequencer configured to automatically execute the Wi-Fi security test modules in the sequence and with the parameters defined by a selected audit profile;
a parameter normalization module configured to apply a multi-factor normalization framework to captured wireless data, the multi-factor normalization framework comprising at least the following components: signal strength normalization applying a log-distance path loss model to decouple access-point signal measurements from operator position variations; interference compensation normalization adjusting measurements relative to a per-channel ambient noise floor baseline established at session initialization; and temporal normalization adjusting traffic-dependent measurements relative to a time-indexed baseline model, thereby producing results that are meaningfully comparable across multiple audit sessions conducted under different physical and environmental conditions;
a results database configured to store audit results in a standardized schema; and
a comparison engine configured to compare audit results across multiple stored audit sessions to identify changes in wireless network security posture.

2. The device of claim 1, wherein the at least one wireless network interface controller comprises a first wireless module and a second wireless module configured for simultaneous independent operation, enabling concurrent monitoring and active testing functions without interruption of either function.

3. The device of claim 1, wherein the at least one antenna assembly comprises a dual external antenna configuration providing independent antenna elements for enhanced signal reception and transmission across the 2.4 GHz and 5 GHz frequency bands.

4. The device of claim 1, wherein the touchscreen display is configured to present a unified audit dashboard displaying at least one of: real-time test execution status; live wireless network threat mapping; signal strength analysis visualization; and compliance status assessment.

5. The device of claim 1, wherein the standardized repeatability engine further comprises a report generation module configured to generate a standardized audit report incorporating test results, comparative security posture analysis, compliance gap identification, and remediation recommendations, wherein the report incorporates a digital signature and timestamp ensuring report integrity and non-repudiation.

6. The device of claim 1, wherein the parameter normalization module is configured to normalize for at least one of: ambient wireless interference; atmospheric signal propagation conditions; physical distance variations in mobile scan paths; and time-of-day variations in network traffic patterns.

7. The device of claim 1, wherein each audit profile stored in the audit profile repository further defines: pass/fail criteria for each test module in the sequence; environmental normalization parameters applicable to the audit context; and an output format specification for the generated audit report.

8. The device of claim 1, further comprising a modular expansion interface configured to receive at least one of: firmware update modules updating the security test capabilities of the standardized repeatability engine; and hardware expansion modules extending the wireless testing capabilities of the device.

9. The device of claim 1, wherein the non-volatile memory further stores a plurality of Wi-Fi security testing modules comprising at least:
a network enumeration module configured to discover and catalog wireless networks and associated security parameters;
a packet capture module configured to capture and store wireless frames on specified channels;
a vulnerability assessment module configured to test wireless networks for known security vulnerabilities;
a rogue access point detection module configured to identify unauthorized wireless access points; and
a compliance assessment module configured to evaluate wireless configurations against defined security standards.

10. The device of claim 1, wherein the touchscreen display is further configured to present a guided audit workflow mode in which the standardized repeatability engine directs the operator through each step of a selected audit profile with contextual prompts and real-time test results.

11. A method for automated Wi-Fi penetration testing and security auditing with standardized repeatability, the method comprising:
receiving, by a processor of a computing device, a selection of a standardized audit profile from an audit profile repository, the audit profile defining an ordered sequence of Wi-Fi security test modules and associated execution parameters;
automatically executing, by a test execution sequencer of the processor, each Wi-Fi security test module in the defined sequence with the defined parameters using at least one wireless network interface controller of the device operating in at least one of monitor mode and managed mode;
applying, by a parameter normalization module of the processor, a multi-factor normalization framework to captured wireless data, the multi-factor normalization framework comprising the following components: signal strength normalization using path loss correction, interference compensation relative to a per-channel ambient noise floor baseline, and temporal normalization relative to a time-indexed traffic baseline model, to produce results that are meaningfully comparable across audit sessions conducted under different physical and environmental conditions;
storing, by a results database, the normalized results from the current audit session in a standardized schema;
comparing, by a comparison engine, the current audit session results against results from at least one prior audit session stored in the results database to identify changes in wireless network security posture; and
generating, by a report generation module, a standardized audit report incorporating the current session results, comparative analysis, and compliance assessment.

12. The method of claim 11, wherein automatically executing each Wi-Fi security test module comprises executing at least one of:
a network enumeration test configured to discover wireless networks and catalog associated security parameters;
a packet capture test configured to capture wireless frames on defined channels;
a vulnerability assessment test configured to identify known security weaknesses in wireless network configurations; and
a rogue access point detection test configured to identify unauthorized wireless access points.

13. The method of claim 11, wherein applying normalization algorithms comprises normalizing for at least one of ambient wireless interference, physical distance variations, and time-of-day network traffic variations, thereby enabling meaningful comparison of results from audit sessions conducted under different conditions.

14. The method of claim 11, further comprising displaying, on a touchscreen display of the computing device, a unified audit dashboard presenting at least one of: real-time execution status of each test module; detected network vulnerabilities; and compliance status during execution of the audit profile.

15. The method of claim 11, wherein generating the standardized audit report further comprises incorporating a digital signature and timestamp ensuring report integrity, and wherein the standardized audit report is formatted to support regulatory compliance documentation.

16. The method of claim 11, wherein comparing the current audit session results against results from at least one prior audit session further comprises: identifying newly detected vulnerabilities not present in the prior audit session; identifying previously detected vulnerabilities that are no longer present in the current session, indicating successful remediation; and generating a quantitative security posture score reflecting the overall change in wireless security status.

17. The method of claim 11, wherein the standardized audit profile is selected from a plurality of profiles corresponding to recognized wireless security compliance frameworks, enabling the method to produce audit documentation directly supporting compliance verification.

18. A standardized repeatability engine for Wi-Fi security auditing, stored in non-volatile memory and executable by a processor of a portable handheld wireless security audit device, the standardized repeatability engine comprising:
an audit profile repository storing a plurality of audit profiles, each audit profile defining a parameterized, ordered sequence of Wi-Fi security test modules and associated execution parameters including scan duration, detection sensitivity, and result evaluation criteria;
a test execution sequencer configured to automatically execute each Wi-Fi security test module in the sequence and with the parameters defined by a selected audit profile, thereby eliminating operator-introduced variability in test execution;
a parameter normalization module configured to normalize environmental variables in captured wireless data to produce results that are meaningfully comparable across audit sessions conducted under different physical and environmental conditions;
a results database configured to store audit results in a standardized schema including result data, normalized measurements, pass/fail determinations, and session metadata; and
a comparison engine configured to compare results stored for a current audit session against results stored for one or more prior audit sessions, and to generate a comparative security posture analysis identifying changes in wireless network vulnerability status over time.

19. The standardized repeatability engine of claim 18, further comprising a report generation module configured to generate a standardized audit report incorporating current session results, comparative analysis, compliance gap identification, and remediation recommendations, wherein the report incorporates integrity verification mechanisms ensuring report non-repudiation.

20. The standardized repeatability engine of claim 18, wherein the audit profile repository is further configured to receive and store updated audit profiles transmitted from a remote profile management server, enabling centralized management of standardized audit methodologies across a plurality of devices.

21. A non-transitory computer-readable medium storing instructions executable by a processor to implement a standardized repeatability engine for Wi-Fi security auditing, the instructions causing the processor to:
maintain an audit profile repository storing a plurality of parameterized audit profiles each defining an ordered sequence of Wi-Fi security test modules and associated execution parameters;
automatically execute, responsive to selection of one of the audit profiles, each Wi-Fi security test module in the defined sequence with the defined parameters using at least one wireless network interface controller operating in at least one of monitor mode and managed mode, thereby eliminating operator-introduced variability in test execution;
apply normalization algorithms to outputs of the executed test modules to produce results that are meaningfully comparable across audit sessions conducted under different physical and environmental conditions;
store normalized audit results in a standardized schema comprising result data, normalized measurements, pass/fail determinations, and session metadata; and
compare results stored for a current audit session against results stored for one or more prior audit sessions to generate a comparative security posture analysis identifying changes in wireless network vulnerability status over time, including identification of newly detected vulnerabilities, remediated vulnerabilities, and a quantitative security posture score.

22. The device of claim 1, wherein the audit profile repository further stores, for each audit profile, a Compliance Mapping Record associating each Wi-Fi security test module in the profile's execution sequence with at least one control requirement drawn from a recognized wireless security compliance framework, and wherein the report generation module is further configured to generate a compliance gap report identifying, for each failed test module, the associated compliance framework control identifier, the test result that identified the control deficiency, and a remediation action required to achieve compliance with the identified control requirement.

23. The device of claim 22, wherein the recognized wireless security compliance framework is at least one of: NIST SP 800-153 wireless LAN security guidelines; ISO/IEC 27001 Annex A network security controls; PCI-DSS wireless environment requirements; and a custom compliance schema defined by an enterprise operator and stored in the audit profile repository.

24. The device of claim 1, wherein the test execution sequencer is further configured to implement a Deterministic Test Sequencing Protocol comprising: verifying, for each test module prior to execution, a set of Execution Invariants defined in the active audit profile; executing the test module within a defined execution window with configurable timeout and retry parameters; evaluating the test module output against acceptance criteria defined in the active audit profile; and, upon determination that the output fails the acceptance criteria due to transient environmental interference, automatically scheduling re-execution of the test module within the current audit session to obtain a valid, stable measurement.

25. The device of claim 1, wherein the standardized repeatability engine is implemented as a versioned modular architecture in which the audit profile repository, test execution sequencer, parameter normalization module, results database, and comparison engine are independently updatable components each carrying a version identifier, and wherein the results database is further configured to record the version identifier of each component in a session record at the time of each audit session, enabling the comparison engine to apply version-specific compatibility transformations when comparing results from audit sessions conducted using different component versions.

26. A wireless security audit normalization system for producing cross-session comparable security measurements, the normalization system comprising: a session initialization module configured to execute a calibration sweep at the start of each audit session, the calibration sweep comprising passive channel scanning across supported frequency bands to measure a per-channel ambient noise floor vector B={b1, b2, . . . , bn}, beacon frame collection from detected access points to establish a signal strength reference map associating each access point with a baseline received signal strength indicator (RSSI) and an estimated path loss exponent for the deployment environment, and traffic volume sampling over a configurable baseline window to establish a current-session traffic activity baseline; a signal strength normalization module configured to apply a log-distance path loss correction to RSSI measurements of the form RSSI_normalized=RSSI_measured−10*n*log10(d/d0)−X_sigma, where n is the environment-type path loss exponent, d0 is a reference distance, d is the estimated measurement distance, and X_sigma is a shadow fading correction term derived from repeated measurements at a fixed reference point; an interference compensation module configured to adjust each RSSI measurement on channel i by the differential (bi−b_ref), where bi is the per-channel noise floor from the current session calibration sweep and b_ref is the noise floor from a reference clean-environment calibration profile, thereby isolating access-point signal components from ambient interference contributions; a temporal normalization module configured to adjust traffic-dependent measurements by a time-indexed traffic baseline model T(h, d) representing expected network activity as a function of hour-of-day h and day-of-week d, producing utilization ratios comparable across sessions conducted at different times; and a session baseline record module configured to store the per-session calibration measurements as a Session Environmental Baseline Record associated with each audit session in a results database, and to supply the Session Environmental Baseline Records for both a current session and a reference session to a comparison engine for differential baseline correction during cross-session security posture analysis.

27. The normalization system of claim 26, wherein the session initialization module is further configured to detect a material change in ambient RF environmental conditions during an active audit session by comparing current per-channel noise floor measurements against the session initialization baseline, and, upon detection of a change exceeding a configurable threshold, to trigger a recalibration cycle before proceeding to a next test module in the audit sequence, thereby ensuring that each test module in the session executes under conditions characterized by a current, valid calibration state.

28. The normalization system of claim 26, further comprising an adaptive threshold module configured to maintain a machine learning model trained on historical audit session data stored in the results database, the machine learning model generating environment-type classifications and associated path loss exponent estimates from measured signal propagation characteristics, thereby enabling the signal strength normalization module to apply environment-specific normalization parameters without requiring manual environment-type configuration by the operator, and further configured to update the machine learning model incrementally with each completed audit session to improve environment classification accuracy over time.

29. The device of claim 1, wherein the standardized repeatability engine further comprises a machine learning anomaly detection module configured to: maintain a behavioral baseline model of normal wireless network activity derived from historical audit session data stored in the results database; analyze current audit session measurements against the behavioral baseline model to compute an anomaly probability score for each detected wireless device and observed network behavior pattern; classify detected anomalies into behavioral categories including unauthorized device introduction, unexpected protocol activation, abnormal authentication pattern, and signal characteristics inconsistent with declared device identity; and incorporate anomaly detection findings as a supplementary finding category in the audit report generated by the report generation module, distinct from signature-based vulnerability findings.

30. The device of claim 29, wherein the machine learning anomaly detection module implements an adaptive threshold mechanism that automatically adjusts detection sensitivity thresholds based on the statistical distribution of measurements observed in prior audit sessions for the same network environment, and wherein the adaptive threshold mechanism applies separate sensitivity calibrations for each behavioral category, enabling detection of subtle security posture degradation that falls below fixed-threshold detection criteria while suppressing false positives in environments with known baseline variability.
